(19) United States
(12) Patent Application Publication
(10) Pub. No.: US 2026/0231872 A1
(43) Pub. Date: Aug. 13, 2026

(54) BIODEGRADABLE AND COMPOSTABLE BAGS FOR GROWING MUSHROOMS

(71) Applicants: KIRBY ALLEN HUDSON, WILMINGTON, DE (US); JAMES EUGENE DAVIDSON, LANDENBURG, PA (US)

(72) Inventors: KIRBY ALLEN HUDSON, WILMINGTON, DE (US); JAMES EUGENE DAVIDSON, LANDENBURG, PA (US)

(21) Appl. No.: 19/051,700

(22) Filed: Feb. 12, 2025

(51) Int. Cl. A01G 18/66; A01G 18/20

(52) U.S. Cl. CPC A01G 18/66; A01G 18/20

(57) ABSTRACT

This invention introduces a biodegradable bag developed for mushroom cultivation, utilizing natural materials such as cornstarch, cellulose, and biodegradable polymers. Its design features micro-perforations that optimize airflow and retain moisture crucial for mushroom mycelium growth, leading to improved growth rates and yields while streamlining handling and transport, thus reducing labor costs. As compostable products, these bags offer a more sustainable alternative to traditional plastic, lowering waste disposal expenses and diminishing reliance on fossil fuels and carbon emissions from plastic production. By providing an eco-friendly solution to the agricultural challenges posed by plastic, the biodegradable bag supports a circular economy and promotes healthier farming practices, marking a significant advancement in the mushroom industry and its environmental impact.

### CROSS-REFERENCE TO RELATED APPLICATIONS

None.

### FIELD OF THE INVENTION

The present invention relates to a novel biodegradable bag. More specifically, the present invention relates to a novel biodegradable bag made from a blend of natural materials, such as cornstarch, cellulose, and other biodegradable polymers. The bag design includes micro-perforation that promote optimal airflow while maintaining moisture levels that are crucial for cultivation essential for mushroom mycelium growth. The biodegradable bag simplifies handling and stacking, leading to reduced labor costs. The bag is easy to fill, transport, and store. The biodegradable bags can be disposed of in composting facilities, significantly lowering waste disposal costs compared to traditional plastic mushroom grow bags. Studies have shown that mushrooms cultivated in the novel biodegradable bags exhibit faster growth rates and improved yields. The biodegradable bag minimizes reliance on fossil fuels and reduces carbon emissions associated with plastic production and finally, the bag's ability to degrade naturally further supports a circular economy.

### BACKGROUND OF THE INVENTION

The mushroom industry faces challenges as it grapples with production growth that is reliant upon outdated farming methods that use tons of plastic bags, plastic wraps, and other types of non-biodegradable plastic items that are harmful to the environment. Plastics are used for everything from mushroom trays and irrigation tubing to large bed liners and mushroom grow bags. As such, the proliferation and use of these plastic products have led to the mounting environmental problems of waste disposal which currently threatens farm soil health, water quality and overall human well-being. A good example of products that are widely used and present environmental concerns are the enormous use of mushroom grow bags and plastic bed liners. Farmers consistently use these types of plastic products to stimulate mushroom growth, to cover and protect the soil against intrusive flies, and to help regulate the facilities room temperature while conserving ambient moisture for optimal growth.

What is needed is an innovative solution that not only facilitates optimal mushroom growth but also mitigates environmental harm. Biodegradable materials have been explored in various agricultural applications, but there is a lack of specialized bags tailored for mushroom cultivation that balance biodegradability and structural integrity of the bag during the growth process.

Further, biodegradable products are known to be commonly used for packaging and carrying various products. However, the present invention discloses a novel use for biodegradable bags in growing mushroom cultivation. The biodegradable bag of the present invention provides a controlled environment for mushroom growth, while allowing for efficient and consistent production due to the available moisture for mushroom growth.

### BRIEF SUMMARY THE INVENTION

A biodegradable and compostable mushroom grow bag is provided, a composition to produce the biodegradable bag, and a process for utilizing the mushroom grow bag for the cultivation of mushroom spawns, such as, white button, crimini, portabella, shiitake, oyster, beech, maitake and king trumpet, and the like.

The bag is configurated with both a front wall and a back wall, a left side gusset wall, and a right-side gusset wall, a sealed bottom, a sealable top, wherein all walls having a plurality of micro-perforations disposed therethrough and throughout thereby creating a circular bag when the sealable top is closed. The micro-perforations are arrayed both horizontally and vertically from the sealable top of the bag to the sealed bottom of the bag. As a result of the positioning of the rows, the size of the micro-perforations, the number of micro-perforations, the position of the micro-perforations, an optimum air flow through the bag is created while the bag decreases the evaporation of moisture out of the bag to reduce dry spots in the mushroom spawn, thereby improving spawn yield.

It is therefore an object of the present invention to provide a biodegradable bag that supports optimal conditions for mushroom cultivation, to develop an eco-friendly alternative to traditional plastic cultivation bags, to minimize environmental impact through the use of sustainable materials, to reduce labor handling cost, to eliminate the disposal cost, and to enhance mushroom yield and quality by creating an ideal growing environment with sufficient water for maximum mushroom yield.

### BRIEF DESCRIPTION OF FOUR (4) VIEWS OF THE DRAWINGS

FIG. 1 of the drawings of the biodegradable bag of the present is a front perspective view of the novel biodegradable bag of the present invention.

FIG. 2 of the drawings of the biodegradable bag of the present is a back perspective view of the novel biodegradable bag of the present invention FIG. 1.

FIG. 3 of the drawings of the biodegradable bag of the present is sideview of left gusset wall of FIG. 1 and FIG. 2.

FIG. 4 of the drawings of the biodegradable bag of the present is sideview of right gusset wall of FIG. 1 and FIG. 2.

### DETAILED DESCRIPTION OF THE PRESENT INVENTION

While the present invention is susceptible of embodiment in many different forms, there is shown in the drawings and will herein be described in detail several specific embodiments with the understanding that the invention is not limited thereto except insofar as those who have the disclosure before them are able to make modifications and variations without departing from the scope and spirit of the present invention.

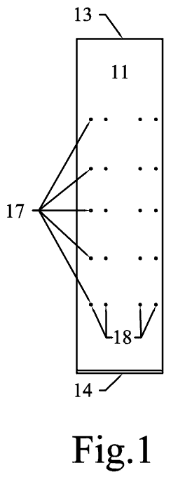

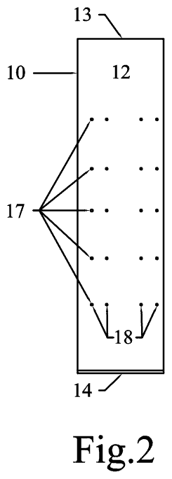

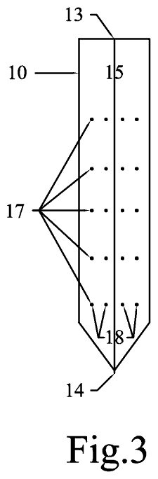

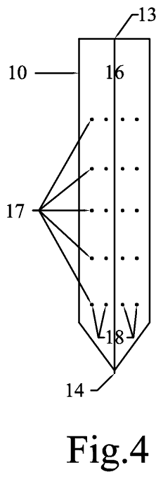

FIG. 1/Fig. of Bag 10 is circular configurated having a front wall 11 FIG. 1, and backwall 12 FIG. 2, that are 28 (twenty-eight) inches in length from a sealable top 13 of bag 10 to a sealed bottom 14, a gusset left side wall 15 of FIG. 3 and a gusset right side wall FIG. 4. 16, wherein all walls have a plurality of horizontal micro-perforations 17 and vertical micro-perforations 18 disposed therethrough bag 10, thereby creating a circular configured bag 10 when the sealable top 13 is closed, using closing apparatus such as a clamp or heat seal technology. The first row of horizontal micro-perforation 17 start 6¾ (six- and three-quarter) inches from the sealable top 13 of bag 10; the second row of horizonal micro-perforation 17 is separated 4¼ (four and one quarter) inches from first row of horizontal micro-perforations 17; the third row of horizonal micro-perforation 17 is separated 3½ (three one half) inches from second row of horizontal micro-perforation 17; the fourth row of horizonal micro-perforation 17 is separated 4 (four) inches from third row of horizontal micro-perforation 17; and, the fifth row of horizonal micro-perforation 17 is separated 4 (four) inches from the fourth row of horizontal micro-perforation 17 and, the fifth row of horizontal micro-perforation 17 is 5½ (five and one half) inches from the sealed bottom 14 of bag 10, wherein sealed bottom 14 is closed by technology available in the prior art, such as heat seal, and the like.

In FIG. 1 and FIG. 2 there are a total of 16 (sixteen) horizontal micro-perforations 17 on each horizontal row for a total of 80 horizontal micro-perforations 17 per bag 10. This count includes horizontal micro-perforations 17 in left gusset wall 15 and horizontal micro-perforations 17 in right gusset wall 16 of bag 10. Bag 10 is specifically designed to include horizontal micro-perforation 17 that promotes optimal airflow while maintaining moisture levels that are crucial for cultivation essential for mushroom mycelium growth and to further help regulate the facilities room temperature while conserving ambient moisture for optimal growth. The horizontal micro-perforations 17 and the vertical micro-perforations 18 disposed throughout bag 10 range in size from approximately ¼ (one quarter) inch to approximately 2 (two) inches in size.

FIG. 3 and FIG. 4 of Bag 10 further consists of a plurality of vertical micro-perforations 18 disposed throughout the 28 twenty-eight-inch-long left gusset side wall 15 and the 28 twenty-eight-inch-long right side gusset wall 16 wherein both gusset walls are triangular inserts used in bag 10 to provide expansion and reinforcement. Gussets can be added to the sides of packaging for increased flexibility and space, or to the bottom for better stability. For example, a side gusset coffee pouch includes gussets on both sides, enabling it to open into a box-like shape, whereas here, the gusset allows bag 10 to be open as a circle. Both the left gusset wall 15 and right wall (16) are identical triangular inserts in bag 10.

In both FIG. 3, and In FIG. 4, the first two (2) columns of vertical micro-perforations 18 are disposed 1 (one) inch from the left gusset side wall 15 and 1 (one) inch from the right gusset side wall 16 of bag 10. The second column of vertical micro-perforations 18 is located 2¼ (two and one quarter) inch from the left gusset side wall and 2¼ (two and one quarter) inch from the right gusset side wall 16 of bag 10. There are a total of 20 (twenty) vertical micro-perforations 18 on each vertical column of closed left gusset side wall 15 and 20 (twenty) vertical micro-perforations 18 disposed in right gusset wall 16 of bag 10, for a total count of 40 micro-perforations disposed throughout for both left gussets side wall 15 of FIG. 3, and right gusset side wall 16 of FIG. 4.

The composition of the biodegradable bag of present invention comprises, includes, consist of or consist essentially of: (a) 1,4-benzenedicarboxylic acid, dimethyl ester C₁₀H₁₀O₄, 194.1840 g/mol, (b) Hexanedioic acid, polymer with 1,4-butanediol, C₁₀H₁₆O₄, 200.2316 g/mol and (c) Poly(L-lactide), CH₃O(C₆H₈O₄)ₙ H Polylactide, PLA, and, (c) Strach (C₆H₁₀Oₙ. In condensation polymers, the repeat unit contains fewer atoms than the monomer or monomers from which it is formed. The subscript “n” denotes the degree of polymerization, that is, the number of units linked together. The biodegradable bag composition of the present invention is composed of a novel formulation designed to address environmental concerns associated with traditional plastic waste, which in composition comprises, may include, or consists of, and essentially consists of the following critical components:
a) 1,4-benzenedicarboxylic acid, dimethyl ester C₁₀H₁₀O₄, 194.1840 g/mol

The composition of the biodegradable bags of the present invention consist of seventy percent (70%) by weight 1,4-benzenedicarboxylic acid, dimethyl ester C₁₀H₁₀O₄, 194.1840 g/mol 1,4-benzenedicarboxylic acid is used for the production of polyesters with aliphatic diols as the comonomer. Diols are organic compounds that serve as building blocks in chemistry. They are formed through reactions such as the reductive dimerization of aldehydes and ketones, and the dihydroxylation of alkenes. The polymer is a high-melting, crystalline material forming very strong fibers. The following Dimethyl terephthalates are also useful in the composition of the present invention and consist of Terephthalic acid, dimethyl ester; Dimethyl p-phthalate; Dimethyl terephthalate; Dimethyl 1,4-benzenedicarboxylate; Methyl 4-(carbomethoxy)benzoate; Dimethyl p-benzenedicarboxylate; Dimethylester kyseliny isoftalove; DMT; NCI-C50055; Dimethylester kyseliny tereftalove; Dimethyl ester of 1,4-benzenedicarboxylic acid; Terephthalate, dimethyl; 1,4-Benzenedicarboxylic acid, 1,4-dimethyl ester; Methyl p-(methoxycarbonyl)benzoate; NSC 3503; Dimethyl terephthalate, and the like; and
(b) Hexanedioic acid, polymer with 1,4-butanediol, C₁₀H₁₆O₄, 200.2316 g/mol. C₁₀H₁₆O₄

Hexanedioic acid, polymer with 1,4-butanediol is a polymeric compound formed by the reaction of hexanedioic acid (also known as adipic acid) with 1,4-butanediol. This compound is commonly used in the production of polyesters and polyurethanes, which are materials with a wide range of industrial applications due to their durability, flexibility, and resistance to various chemicals. The material can be broken down by hydrolysis into its monomeric units, making it suitable as a biodegradable material.

Poly(L-lactide), CH₃O(C₆H₈O₄)ₙ H Polylactide, PLA, is a biodegradable thermoplastic derived from natural lactic acid from corn, maize, or milk. Polylactic acid (PLA) is a thermoplastic, aliphatic polyester, produced from non-toxic renewable feedstock, naturally occurring organic acid, or made by fermentation of sugars obtained from renewable resources such as sugarcane. Unlike conventional plastics, which are derived from fossil fuels and can take hundreds of years to break down, PLA is derived from renewable resources, and under specific conditions, it can decompose within a few months. This makes PLA a promising option for reducing plastic waste and supporting a circular economy.

Both hexanedioic acid, polymer with 1,4-butanediol, C₁₀H₁₆O₄, 200.2316 g/mol and (c) Poly(L-lactide), CH₃O(C₆H₈O₄)ₙ H Polylactide, PLA, are 5 (five) percent by weight of the composition of the bag of the present invention for option growth conditions, such as moister content for maximum growth and product yield,
(c). Starch

Starch is a polysaccharide that serves as a major form of energy storage in plants. Its chemical composition consists of two types of molecules: Amylose: This is a linear polymer of glucose units linked together primarily by α-1,4 glycosidic bonds. Amylose typically makes up about 20-30% of starch. Amylopectin: This is a branched polymer of glucose that contains both α-1,4 glycosidic bonds and α-1,6 glycosidic bonds at the branching points. Amylopectin usually comprises about 70-80% percent of starch. The branching structure contributes to its solubility and digestibility. The general formula for starch can be represented as (C₆H₁₀O₅)ₙ where n represents the number of glucose units, which can range from a few hundred to several thousand. The molecular weight of starch can vary significantly due to its polymeric nature and can range from about 1,000 g/mol for small oligomers (short chains of glucose units) to several million g/mol for very large starch molecules. Starch is biodegradable for several reasons:
Natural Polymer: Being a natural polysaccharide, starch is produced by living organisms (plants), making it more easily broken down by biological systems compared to synthetic polymers.
Microbial Decomposition: Many microorganisms, including bacteria and fungi, possess enzymes such as amylases that can hydrolyze starch into its constituent glucose units. These microorganisms utilize starch as an energy source, breaking it down into simpler compounds during the decomposition process.
Environmental Conditions: In the presence of moisture and suitable temperatures, microorganisms can thrive and effectively degrade starch. Under these conditions, starch can be metabolized into carbon dioxide, water, and biomass, contributing to the natural recycling of nutrients in ecosystems.
Biodegradation Compared to Plastics: Unlike many synthetic materials, which may persist in the environment for decades or centuries, starch decomposes relatively quickly, typically within a few weeks to months, depending on environmental factors.

Overall, its natural origin, the presence of specific enzymes, and the favorable environmental conditions facilitate the breakdown of starch, making it a biodegradable material that poses less environmental risk compared to synthetic plastic polymers. The following list of starches that may be utilized in the composition of the biodegradable bag of the present invention, include corn starch, potato starch, tapioca starch, wheat starch, rice starch and modified starches i.e., chemically or physically altered to enhance properties like thickening or gelling used in various industrial applications. In conclusion, the inventive biodegradable bag of the present invention combines four components in unique proportions to create a material that is not only strong and flexible but also environmentally sustainable. By leveraging the biodegradability of its constituents, particularly through the use of renewable resources, the composition minimizes the environmental impact associated with traditional plastic products. This innovative formulation embodies a significant advancement in the quest for sustainable packaging solutions, ensuring that the bags produced are both effective in their function and responsible in their environmental footprint.

The biodegradable mushroom grow bags of the present invention are crafted from a proprietary blend of naturally sourced materials designed to promote sustainable growth while minimizing environmental impact. The primary components of our grow bags include (a) plant-based polymers (60-70% percent by weight), made from renewable sources such as corn starch, sugarcane, and other bio-based feedstocks, these polymers provide strength and flexibility while ensuring biodegradability; (b) cellulose (20-30% percent) from sustainably harvested wood or agricultural residues, cellulose fibers enhance the grow bag's structural integrity and water retention abilities, fostering optimal conditions for mushroom cultivation; (c) natural fillers (5-15% percent): incorporating materials like rice hulls or wheat bran, these fillers improve aeration and drainage within the grow bag, ensuring a healthy growing environment for mycelium; and, (d) natural biopolymers (5-10% percent), extracts from sources such as seaweed (e.g., alginate) contribute to the overall biodegradable properties, enhancing moisture retention and providing essential nutrients to the growing mycelium. All percentages are by weight, grams per mole. This composition ensures that our mushroom grow bags are fully biodegradable, breaking down into natural components within six months to twelve months in appropriate composting conditions, thus promoting soil health and reducing plastic waste in the environment.

The biodegradable bags of the present invention may be filled with any substrate that is suitable for growing mushrooms such as, white button, crimini, portabella, shiitake, oyster, beech, maitake and king trumpet and the like. A mushroom substrate is the material used to provide the nutrients and support necessary for mushroom growth. It serves as a medium in which mycelium—the vegetative part of fungi—can thrive and eventually produce mushrooms. The composition of the substrate can vary widely depending on the type of mushroom being cultivated, but it generally includes organic materials that are rich in nutrients. Common components of mushroom substrates include materials such as straw, sawdust, corn husks, wheat bran, or rice hulls are often used. These byproducts are typically abundant and help reduce waste. Sometimes, additional nutrients are added to the substrate to promote optimal growth. This can include materials like soybean meal, gypsum, or agricultural lime. The substrate must maintain a suitable moisture content to support mycelium growth. This often requires careful preparation and sterilization to eliminate unwanted microorganisms. The pH of the substrate can also affect mushroom growth, with many species preferring a slightly acidic to neutral pH range. To prevent contamination from other microorganisms, substrates are often sterilized or pasteurized. This is an essential step in commercial mushroom cultivation. Different mushrooms may require specific substrates. For example, oyster mushrooms thrive on wheat straw or sawdust, whereas shiitake mushrooms often grow best on hardwood sawdust or logs. The present method leverages an innovative biodegradable bag design optimized for mushroom cultivation, promoting sustainable agricultural practices while minimizing environmental impact through its biodegradable composition.

### Physical Properties of Biodegradable Bag

This document outlines the chemical and physical properties of our biodegradable and compostable bag made from cornstarch as the main component. The bag composition includes, and consist of 1,4-Benzenedicarboxylic acid, dimethyl ester 70%, polymer with 1,4-butanediol and hexanedioic acid poly(L-lactide) 5%, and cornstarch 25%. Below are the detailed properties and tests used to determine them.

| Property | Test Method | Expected Value | |
|---|---|---|---|
| Breaking Strength | ASTM D638 (Tensile Testing) | 20-40 | MPa |
| Color | Visual Inspection & Colorimeter | Greenish milky | |
| | Testing | white with a | |
| | | slightly translucent | |
| | | appearance | |
| Crystallinity | X-ray Diffraction (XRD) or DSC | 20%-40% | |
| Density | ASTM D792 (Density and Specific | 1.2 | g/cm³ |
| | Gravity of Plastics) | | |
| Elasticity (Young's | ASTM D638 (Tensile Testing for | 500-3000 | MPa |
| Modulus) | Elasticity) | | |
| Electrical | ASTM D257 (Measuring Resistivity) | Low Electrical | |
| Conductivity | | Conductivity | |
| Elongation | ASTM D638 (Tensile Testing) | 100%-300% | |
| Flexibility | ASTM D790 (Flexural Properties) | Moderate | |
| Glass Transition | Differential Scanning Calorimetry | 55° | C. |
| Temperature | (DSC) | | |
| Hardness | ASTM D2240 (Durometer Hardness | Shore D 40-60 | |
| | Test | | |
| Melting Point | ASTM D3418 (Melting Point by DSC) | >120° C. (Softening) | |
| Odor | Sensory Evaluation | Weak Odor | |
| Solubility | ASTM D1127 (Solubility Testing) | Slightly Soluble in | |
| | | Water | |
| Tensile Strength | ASTM D638 (Tensile Properties of | 10-40 | MPa |
| | Plastics) | | |
| Thickness | Direct Measurement (Micrometer or | 70 | microns |
| | Caliper) | | |
| Transparency | ASTM D1003 (Haze and Luminous | Opaque | |
| | Transmittance) | | |

Study Summary: Comparison of Biodegradable Bag vs. Polypropylene Bag for Mushroom Cultivation

In this study, the effectiveness of our new biodegradable bag for mushroom cultivation was evaluated over a three-month period. A polypropylene vented bag was used as a control. Both bags were filled with the same substrate.

Key points of the study:
1. Experimental Design:
   The biodegradable bag and the polypropylene bag were used simultaneously to grow mushrooms.
   Each bag was filled with the same substrate and monitored for growth and water retention.
2. Results:
   Over a three-month period, our biodegradable bag demonstrated superior performance in terms of water retention, compared to the control polypropylene bag.
   This suggests that the biodegradable bag may provide a more favorable environment for mushroom growth.
3. Conclusion:
   The biodegradable bag not only supports mushroom cultivation but also performs better in maintaining moisture levels compared to traditional plastic options and the bag decomposes in six months to one year.

We claim:

1. A biodegradable bag, comprising:
a circular configuration having a front wall and a back wall, each 28 inches in length, a sealable top and a sealed bottom;
a left gusset side wall and a right gusset side wall that promote expansion and reinforcement of the bag, wherein both gusset walls provide stability and facilitate opening of the bag in a circular form; and,
a plurality of micro-perforations distributed horizontally and vertically across all walls of the bag to enhance airflow and regulate moisture levels, crucial for the cultivation of mushroom mycelium.

2. The biodegradable bag of claim 1, wherein the horizontal micro-perforations include:
a first horizontal row positioned approximately 6¾ inches from the sealable top;
subsequent horizontal rows spaced at specific intervals (4¼ inches, 3½ inches, 4 inches, and 4 inches) for a total of 80 horizontal micro-perforations distributed across all walls, including both gusset walls; and,
micro-perforations ranging in size from approximately ¼ inch to approximately 2 inches.

3. The biodegradable bag of claim 1, wherein the vertical micro-perforations include:
a total of 40 vertical micro-perforations distributed in two columns along the left and right gussets, positioned at specified distances from the walls, to further enhance airflow; and,
vertical micro-perforations placed 1 (one) inch and 2¼ (two and one-quarter) inches from both of the respective gusset walls.

4. The biodegradable bag of claim 1, wherein the closing apparatus for the sealable top includes methods selected from the group consisting of clamps and heat seal technology, ensuring secure closure after filling the bag.

5. The biodegradable bag of claim 1, wherein the entire composition of the bag is made from biodegradable materials that break down naturally over time, minimizing environmental impact compared to conventional plastic bags.

6. The biodegradable bag of claim 1, wherein the design of the bag is specifically optimized for mushroom cultivation, capable of providing a suitable environment for mycelium growth through its micro-perforated structure.

7. The composition of the biodegradable bag of the present invention comprises the following critical components:
a. 1,4-benzenedicarboxylic acid, dimethyl ester (C₁₀H₁₀O₄, 194.1840 g/mol) in a proportion of 70% by weight;
b. Hexanedioic acid, polymer with 1,4-butanediol (C₁₀H₁₆O₄, 200.2316 g/mol) in a proportion of 5% by weight; and, Poly(L-lactide) (Polylactide, CH₃O(C₆H₈O₄)ₙ H) in a proportion of 5% by weight; and,
c. Starch (C₆H₁₀ON is 112.1497 g/mol) in a proportion of 20% by weight.

8. A method for cultivating mushrooms using biodegradable bag of the present invention comprising the steps of:
providing a biodegradable bag as defined in claim 1, wherein the bag has been configured to have a circular shape with a front wall, a back wall, sealed top, sealed bottom, and gusset side walls that promote structural integrity and facilitate airflow;
filling the biodegradable bag with substrate material suitable for supporting mushroom mycelium growth, ensuring the substrate is evenly distributed across the interior of the bag;
securing the sealable top of the biodegradable bag using a closing apparatus selected from the group consisting of clamps or heat seal technology, to create an airtight environment that supports optimal moisture levels and protects against contamination during the incubation phase;
incubating the filled and sealed biodegradable bag in a suitable environment that provides appropriate temperature, humidity, and light conditions for the growth of mushroom mycelium;
inducing fruiting conditions by either performing controlled openings of the micro-perforations to enhance airflow and gas exchange, or by adjusting environmental parameters, thereby allowing the developed mycelium to transition into the fruiting phase resulting in mushroom production; and,
harvesting the mushrooms after a predetermined growth period, after which the biodegradable bag, alongside its contents, is permitted to decompose naturally in the environment, thereby minimizing landfill contributions and enhancing sustainability.

9. The method of claim 8, wherein the substrate material comprises:
a mixture of organic materials, such as straw, sawdust, or agricultural waste products,

10. The method of claim 8, wherein the controlled openings of the micro-perforations occur at specific growth stages, including during the pinning and primordia development stages of mushroom cultivation to regulate humidity and optimize conditions for fruiting.

11. The method of claim 8, wherein the natural decomposition of the biodegradable bag after harvest is further supported by environmental factors, such as the presence of microorganisms and moisture in the soil, enhancing eco-friendliness and returning nutrients to the soil.

12. The method of claim 8, utilizing the unique composition of the bag materials, as detailed in the composition claim, to ensure that the biodegradable bag retains strength and flexibility during the critical phases of mushroom cultivation, thus allowing for safe handling and minimal risk of rupture or contamination.

13. The method of claim 8, designed for scalability, allowing multiple biodegradable bags to be cultivated simultaneously in various environments, adapting the method to different types of mushrooms and regional conditions while maintaining the system's ecological benefits.
